(19) United States
(12) Patent Application Publication
(10) Pub. No.: US 2026/0311590 A1
(43) Pub. Date: Oct. 8, 2026

(54) WEARABLE DEVICE FOR ALERTING FIRST RESPONDERS

(71) Applicant: Cheryl Valentine, Middletown, NY (US)

(72) Inventor: Cheryl Valentine, Middletown, NY (US)

(21) Appl. No.: 19/569,933

(22) Filed: Mar. 17, 2026

Related U.S. Application Data
(60) Provisional application No. 63/784,439, filed on Apr. 7, 2025.

(51) Int. Cl. G08B 25/01; G04G 17/04; G04G 21/02; G04G 21/06

(52) U.S. Cl. CPC G08B 25/016; G04G 17/045; G04G 21/02; G04G 21/06

(57) ABSTRACT

A wearable device for alerting first responders, including a smart watch, including an emergency alert button to cause an alert to be sent to third party upon depression and activation, a GPS mode button to cause a location of the a to be sent to the third party upon depression and activation, a communication mode button to cause a phone number of the third party to be dialed upon depression and activation, an activation button to allow activation of each one of the emergency alert button, the GPS mode button, and the communication mode button, and a display screen disposed on a front surface of the smart watch, and a wrist band connected to the smart watch to allow the user to wear the smart watch around a wrist of the user.

### CROSS-REFERENCE TO RELATED APPLICATIONS

This application claims priority under 35 USC § 120 from U.S. Provisional Application No. 63/784,439, entitled “Wearable Device For Alerting First Responders,” which was filed on Apr. 7, 2025, in the United States Patent and Trademark Office, the disclosure of which is incorporated herein in its entirety by reference.

### BACKGROUND

### 1. Field

The present general inventive concept relates generally to a fishing-related device, and particularly, to a casting device.

### 2. Description of the Related Art

In today's tumultuous world, personal safety has become an increasing concern.

There are many different types of emergencies that require immediate response from police, firefighters, medics, or other types of first responders.

For example, when a victim of bullying, abduction, domestic violence, or fire requires assistance, fast and immediate response from first responders may often mean the difference between life and death.

Therefore, there is a need for a device that allows for first responders to quickly and efficiently find a victim in need of help.

### SUMMARY

The present general inventive concept provides a wearable device for alerting first responders.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a wearable device for alerting first responders, including a smart watch, including an emergency alert button to cause an alert to be sent to third party upon depression and activation, a GPS mode button to cause a location of the a to be sent to the third party upon depression and activation, a communication mode button to cause a phone number of the third party to be dialed upon depression and activation, an activation button to allow activation of each one of the emergency alert button, the GPS mode button, and the communication mode button, such that the emergency alert button, the GPS mode button, and the communication mode button are activated only when the activation button is simultaneously pressed along with a pressing of the emergency alert button, the GPS mode button, or the communication mode button, respectively, and a display screen disposed on a front surface of the smart watch to display a mode that the smart watch is presently in based on a depression of one of the emergency alert button, the GPS mode button, and the communication mode button, and a wrist band connected to the smart watch to allow the user to wear the smart watch around a wrist of the user.

The display screen may be configured to display at least one of a temperature of an environment where the smart watch is located, a present time, an APP that is running on the smart watch, a phone number that is being called, a keypad to dial a phone number of a family member, a phone number of a first responder, a video, and a real-time video communication with the third party.

The wearable device for alerting first responders may further include a microphone to allow the user to speak into the smart watch to allow the third party to hear the user, and a speaker to allow the user to hear the third party with whom the user is speaking.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a wearable device for alerting first responders, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Mobile Device 10
Wearable Device for Alerting First Responders 100
Smart Watch 110
Central Processing Unit (CPU) 111
Display Screen 112
Microphone 113
Speaker 114
Activation Button 115
Emergency Alert Button 116
GPS Mode Button 117
Communication Mode Button 118
Temperature Sensor 119
Wrist Band 120

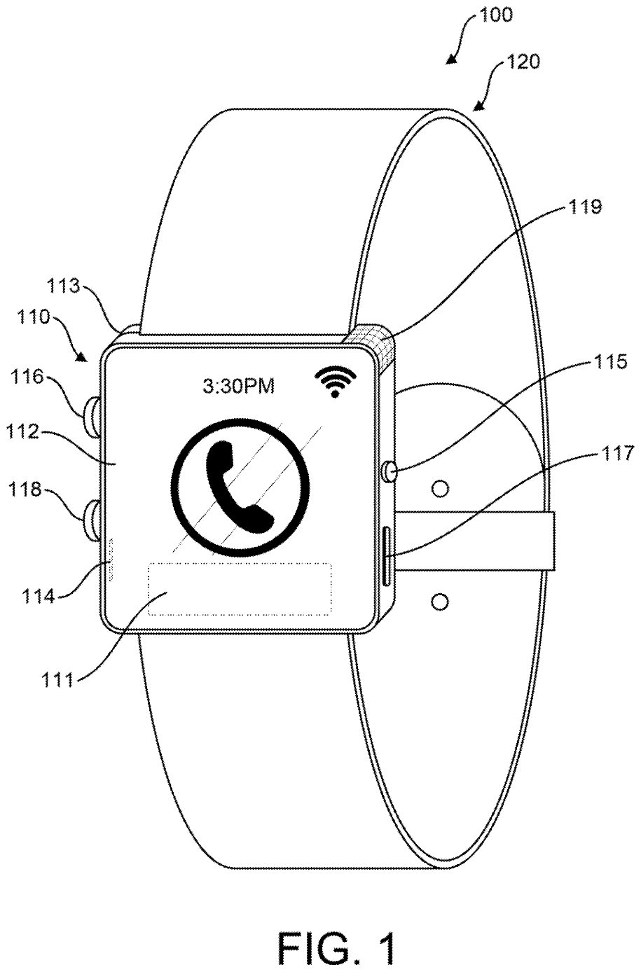

FIG. 1 illustrates a wearable device for alerting first responders 100, according to an exemplary embodiment of the present general inventive concept.

The wearable device for alerting first responders 100, and all components therein, may be constructed from at least one of wood, plastic, paper, metal, silicone, liquid, fibers, threads, fabric, foam, sponge, nylon, vinyl, feathers, glass, adhesives, circuitry, and rubber, etc., but is not limited thereto, and can be constructed from any material known to one of ordinary skill in the art.

The wearable device for alerting first responders 100 may include a smart watch 110, and a wrist band 120 connected to the smart watch 110, which allows a user to wear the wearable device for alerting first responders 100, but is not limited thereto, and may include more components not mentioned herein.

The wrist band 120 may be any type of wrist band known to one of ordinary skill in the art, and may be adjustable, expandable, flexible, etc.

The smart watch 110 may be constructed from material to make it waterproof, shockproof, and shatterproof, and may communicate with a mobile device 10 (e.g., a cell phone, a laptop computer, a tablet computer, a smart phone, etc.), based on a user's preference.

The smart watch 110 may include a central processing unit (CPU) 111, a display screen 112, a microphone 113, a speaker 114, an activation button 115, an emergency alert button 116, a GPS mode button 117, a communication mode button 118, and a temperature sensor 119, but is not limited thereto.

The central processing unit (CPU) 111 may be disposed within the smart watch 110, and may include electronic circuitry to carry out instructions of a computer program by performing basic arithmetic, logical, control and input/output (I/O) operations specified by the instructions. The CPU 111 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The CPU 111 may also include a microprocessor and a microcontroller. The CPU 111 may be a local computer device, a remote server, or cloud computing device.

The CPU 111 may also include a storage unit, a random access memory (RAM), a read-only memory (ROM), a hard disk, a flash drive, a database connected to the Internet, cloud-based storage, Internet-based storage, or any other type of storage unit.

The CPU 111 may access the Internet via an internal communication unit to allow the CPU 111 to access a website, and/or may allow for communication with a mobile application and/or a software application, and may also allow for communication between the smart watch 110 and the mobile device 10. The communication unit may include various wireless capabilities including, but not limited to, WIFI, Bluetooth, cellular, near field communications (NFC), etc. For ease of description, the mobile and/or the software application will be hereinafter referred to as an app. The app may be downloaded from the Internet to be stored on the storage unit of the CPU 111, and the app may also be downloaded to the mobile device 10 to allow for communication between the smart watch 110 and the mobile device 10.

The CPU 111 may also have a global positioning service (GPS) device installed therein, to allow the CPU 111 to be located via a GPS signal.

The CPU 111 may also allow the user to utilize the smart watch 110 as a telephone to call a family member, a first responder, etc.

Thus, the CPU 111 may allow a user to control the smart watch 110 and various components of the smart watch 110 directly disposed on the smart watch 110, or may also allow the smart watch 110 to be controlled and/or accessed via the mobile device 10.

The display screen 112 may be disposed on a front portion of the smart watch 110, and may be any type of display screen known to one of ordinary skill in the art, including, but not limited to, a touch screen, an LED screen, an OLED screen, an LCD screen, a plasma screen, etc. The display screen 112 may display a mode that the smart watch 110 is presently in based on one of the emergency alert button 116, the GPS mode button 117, and the communication mode button 118 being pressed by a user. Also, the display screen 112 may display a temperature of an environment where the smart watch 110 is located, a present time, an APP that is running on the smart watch 110, a phone number that is being called, a keypad to dial a phone number of a family member, a first responder, etc., a video, and/or a real-time video communication with a third party. The display screen 112 or the mobile device 10 may also allow a user to program the CPU 111 to include various phone numbers of first responders, family members, geofencing criteria, or any other type of information related to the various functions and/or components of the smart watch 110.

The microphone 113 may allow a user to speak into the smart watch 110 to allow a third party to hear the user, and the speaker 114 may allow the user to hear the third party with whom the user is speaking.

The activation button 115 may be pressed to allow one of the emergency alert button 116, the GPS mode button 117, or the communication mode button 118 to be activated. Specifically, in order to prevent accidental pressing of one of the emergency alert button 116, the GPS mode button 117, or the communication mode button 118, the activation button 115 must be held down while concurrently pressing one of the emergency alert button 116, the GPS mode button 117, or the communication mode button 118 to cause one of the emergency alert button 116, the GPS mode button 117, or the communication mode button 118 to activate.

The emergency alert button 116 may be pressed by a user to cause an alert to be sent to a first responder, such as a police department and/or a fire department, or may even cause an alert to be sent to a family member, based on a user's preference. In other words, when the activation button 115 and the emergency alert button 116 are pressed simultaneously, the display screen 112 may display a phone number, an address, and/or an identifier of a local police station, fire department, and family member, for example, to allow the user to select one of the above to be alerted of the user's location (via GPS) and type of emergency, via the display screen 112. The police station, the fire department, and/or the family member must also have the mobile device 10 with the APP running thereon to receive the alert.

The GPS mode button 117 may be pressed by a user to cause a location of the user to be sent to a third party such as a first responder, such as a police department and/or a fire department, or may even cause an alert to be sent to a family member, based on a user's preference. In other words, when the activation button 115 and the GPS mode button 117 are pressed simultaneously, the smart watch 110 may send, via the CPU 111, a location of the user to a local police station, a fire department, and/or a family member. The police station, the fire department, and/or the family member must also have the mobile device 10 with the APP running thereon to receive the location of the user. Also, the smart watch 110 may be programmed to require the user to be geofenced, and if the user moves out of a certain location, a third party may be automatically alerted that the user is no longer in the zone where the user should have stayed. This can help for automatic location of a child that is being kidnapped, for example.

The communication mode button 118 may be pressed by a user to cause a phone number of a third party to be dialed, such as a phone number of a police department and/or a fire department, or may even cause a phone number of a family member to be dialed, based on a user's preference. In other words, when the activation button 115 and the communication mode button 118 are pressed simultaneously, the display screen 112 may display the phone number of a local police station, fire department, and family member, for example, to allow the user to select one of the above to be dialed, via the display screen 112. The third party (e.g., the police station, the fire department, and/or the family member) may also have the mobile device 10 with the APP running thereon to receive the call from the smart watch 110, or alternatively, a main phone number of the third party may be dialed without requiring the third party to have the mobile device with the APP running thereon. Once the phone number is dialed and the third party picks up the phone, a conversation may be had between the user and the third party.

The temperature sensor 119 may sense a temperature external to the smart watch 110, and may cause an alert to be sent to a third party having the mobile device 10. For example, if a child wearing the wearable device for alerting first responders 100 is left in an automobile that is too hot, the temperature sensor 119 may sense that a temperature within the car is over a predetermined temperature, and the wearable device for alerting first responders 100 may send an alert via the CPU 111 to the parent through the mobile device 10.

The present general inventive concept serves as a central device integrating all safety functions within a user-friendly interface. One of the standout features is the emergency alert button. This discreet button allows users to activate a silent alert to pre-set contacts, ensuring that help can be summoned without alerting a potential intruder. This silent functionality is crucial in high-stress situations, as it minimizes the risk of escalation. To further enhance communication, the watch includes a microphone and speaker, enabling two-way conversations with emergency contacts. This feature allows users to provide immediate context to their situation, ensuring that help is appropriately tailored to their needs. The wristband is crafted from comfortable, silicone possessing an adjustable strap. making it suitable for various activities and available in multiple colors to appeal to users of all ages due to its compact and lightweight design. The incorporation of a solar/temperature sensor is particularly innovative. It monitors ambient temperature, sending alerts to parents if conditions become unsafe, such as when a child is left in a hot vehicle, for example, if temperatures exceed 65-70 degrees, the accessory, while having a 5 min delay to prevent false alarms would proactively send notifications to the parents' smartphone as a reminder to check on the child. This feature can be a lifesaver, as it helps prevent heat-related incidents. Additionally, the activate/deactivate button allows users to easily toggle the alert system on and off, providing control and flexibility. The SOS mode button activates continuous location updates to emergency contacts, ensuring that loved ones can track the user until the situation is resolved, a benefit for situations related to bullying. A companion app complements the smart watch, offering real-time GPS tracking, geofencing notifications, and the ability to manage user settings. Geofencing allows parents to set safe zones for their children, receiving alerts if the child leaves these designated areas. Possessing a primary communication button, the present general inventive concept enables quick voice calls or messages to pre-set emergency contacts, ensuring that help is just a button press away.

A main purpose of the present general inventive concept is to enhance personal safety for individuals of all ages, particularly children and vulnerable adults. By integrating advanced technology such as real-time tracking, emergency alerts, and two-way communication, the present general inventive concept aims to provide immediate response capabilities in a variety of threatening situations. This innovative watch is designed not only to empower users but also to offer peace of mind to parents and guardians. In today's world, where safety concerns are prevalent, the present general inventive concept serves as a proactive solution, fostering a safer environment in schools and communities while ensuring that individuals can alert trusted contacts in emergencies. The present general inventive concept comprises several essential components that work together to provide comprehensive safety features. At the core is the smartwatch, a waterproof and shockproof accessory which serves as the central device integrating all safety functions within a user-friendly interface. One of the standout features is the emergency alert button. This discreet button allows users to activate a silent alert to pre-set contacts, ensuring that help can be summoned without alerting a potential intruder. This silent functionality is crucial in high-stress situations, as it minimizes the risk of escalation. To further enhance communication, the watch includes a microphone and speaker, enabling two-way conversations with emergency contacts. This feature allows users to provide immediate context to their situation, ensuring that help is appropriately tailored to their needs. The wristband is crafted from comfortable, silicone possessing an adjustable strap. making it suitable for various activities and available in multiple colors to appeal to users of all ages due to its compact and lightweight design. The incorporation of a solar/temperature sensor is particularly innovative. It monitors ambient temperature, sending alerts to parents if conditions become unsafe, such as when a child is left in a hot vehicle, for example, if temperatures exceed 65-70 degrees, the accessory, while having a 5 min delay to prevent false alarms would proactively send notifications to the parents smartphone as a reminder to check on the child. This feature can be a lifesaver, as it helps prevent heat-related incidents. Additionally, the activate/deactivate button allows users to easily toggle the alert system on and off, providing control and flexibility. The GPS mode button activates continuous location updates to emergency contacts, ensuring that loved ones can track the user until the situation is resolved, a benefit for situations related to bullying. A companion app complements the smartwatch, offering real-time GPS tracking, geofencing notifications, and the ability to manage user settings. Geofencing allows parents to set safe zones for their children, receiving alerts if the child leaves these designated areas. Possessing a primary communication mode button, the present general inventive concept enables quick voice calls or messages to pre-set emergency contacts, ensuring that help is just a button press away.

The present general inventive concept effectively addresses several critical safety concerns that many families face today. One of the most pressing issues it tackles is the need for immediate alerts during emergencies, such as bullying, abductions, or instances of domestic violence. With its silent alert feature, users can call for help discreetly, minimizing the risk of escalating dangerous situations. The watch's geofencing capabilities allow parents to establish safe zones for their children, significantly enhancing supervision and reducing anxiety. Parents receive notifications if their child leaves these safe zones, providing an added layer of security. Additionally, the watch's temperature monitoring feature offers peace of mind by alerting caregivers if a vehicle becomes too hot, thus helping to prevent tragic accidents involving children left in cars while the real-time GPS tracking feature ensures that individuals can be located quickly in emergencies, aiding in situations such as missing persons or lost hikers. This functionality is invaluable not only for children but also for vulnerable adults, such as those with dementia, who may wander off. The two-way communication capabilities ensure that users can speak directly with emergency contacts, providing them with the necessary information to respond effectively. Overall, the present general inventive concept combines cutting-edge technology with practical safety features to create a versatile solution for a wide range of threats. By focusing on emergency preparedness and effective communication, it ensures that users can stay safe and connected in an increasingly uncertain world.

The present general inventive concept is unique due its comprehensive integration of safety features tailored specifically for both children and adults, providing a proactive approach to personal security. Unlike typical smartwatches, the present general inventive concept combines silent emergency alerts, real-time GPS tracking, geofencing capabilities, and two-way communication in one discreet device. Its innovative temperature monitoring sensor adds an extra layer of safety for children left in vehicles, while the user-friendly design and customizable settings cater to diverse needs. Designed with a commitment that all data transmitted between the watch and supportive apps are encrypted to protect user privacy, the present general inventive concept also possesses a primary display that is easily readable in bright sunlight and features a night mode option that ensures complete darkness. Furthermore, the watch employs a long-lasting battery with a low-power mode to extend usage between charges along with solar capabilities as a power source and it provides multi language options in the app and watch interface to help cater to broader audiences. All of these design benefits along with the focus on immediate safety response without distractions like games or entertainment content sets the present general inventive concept apart as a dedicated safety device, ensuring users can navigate their environments with confidence and security.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A wearable device for alerting first responders, comprising:
a smart watch, comprising:
an emergency alert button to cause an alert to be sent to third party upon depression and activation,
a GPS mode button to cause a location of the a to be sent to the third party upon depression and activation,
a communication mode button to cause a phone number of the third party to be dialed upon depression and activation,
an activation button to allow activation of each one of the emergency alert button, the GPS mode button, and the communication mode button, such that the emergency alert button, the GPS mode button, and the communication mode button are activated only when the activation button is simultaneously pressed along with a pressing of the emergency alert button, the GPS mode button, or the communication mode button, respectively, and
a display screen disposed on a front surface of the smart watch to display a mode that the smart watch is presently in based on a depression of one of the emergency alert button, the GPS mode button, and the communication mode button; and
a wrist band connected to the smart watch to allow the user to wear the smart watch around a wrist of the user.

2. The wearable device for alerting first responders of claim 1, wherein the display screen is configured to display at least one of a temperature of an environment where the smart watch is located, a present time, an APP that is running on the smart watch, a phone number that is being called, a keypad to dial a phone number of a family member, a phone number of a first responder, a video, and a real-time video communication with the third party.

3. The wearable device for alerting first responders of claim 1, further comprising:
a microphone to allow the user to speak into the smart watch to allow the third party to hear the user; and
a speaker to allow the user to hear the third party with whom the user is speaking.
